(19) United States
(12) Patent Application Publication
(10) Pub. No.: US 2006/0151248 A1
(43) Pub. Date: Jul. 13, 2006

(54) Easy tire lift

(76) Inventors: Hugo Rodriguez, El Monte, CA (US); Mario Luna Alonzo, Goshen, CA (US)

Correspondence Address: HUGO RODRIGUEZ, Apt. #2, 11734 Lansdale Ave., El Monte, CA, 91732, US

(21) Appl. No.: 10/999,063

(22) Filed: Nov. 30, 2004

(51) Int. Cl. B66F 9/06

(52) U.S. Cl. 187/222

(57) ABSTRACT

This device, The Easy Tire Lift, will be useful in the field of tire removal or installment. It will save a person time and energy by enabling him/her to change the wheels of any kind of vehicle faster and easier than ever before. Such device will be of great use at tire shops and to any person in general. Its foldaway parts make it more convenient to carry it around because it saves space and can be stored quickly when not being used.

### BRIEF SUMMARY OF THE INVENTION

This device has been invented to solve a recurring problem which happens every time a person needs to change tires on his/her vehicle. Up until now people keep using their hands, legs, and other awkward devices to help them install or remove wheels on their vehicles, in some cases resulting in injury.

To prevent that from happening, this device comes into play. It is very helpful in carrying and lifting the tire(s) to be installed on or removed from the vehicle. The existing problem lies on trying to align the wholes of the wheel with the studs on the rotor, since the rotor is proned to rotate. With this device the task of mounting the wheel(s) on the vehicle becomes easier and faster, for once the tire is placed on this device you rotate the wheel to align its holes with the studs of the rotor with much more precision, and slide the wheel right on place.

It is the hope of the inventors that all the people who own a vehicle, or a tire shop, will have a good use for the Easy Tire Lift.

### BRIEF DESCRIPTION OF THE SEVERAL VIEWS OF THE DRAWINGS

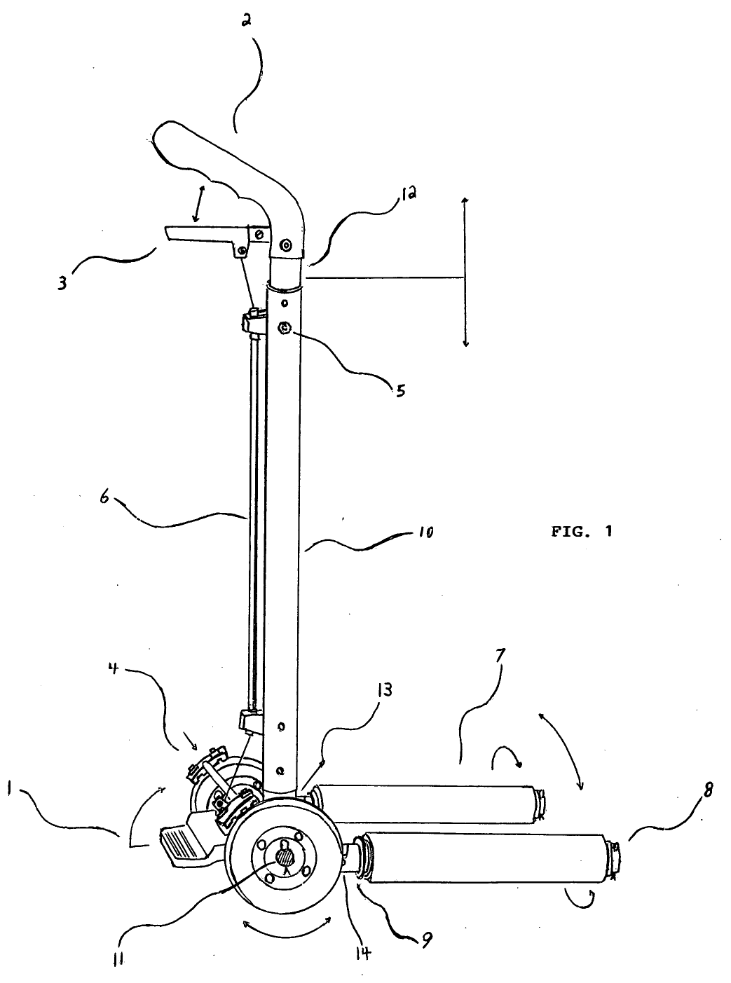

### FIG. 1

1. Foldaway Step Pedal—helps control the device with the foot.
2. Handle Grip—guides and controls the device.
3. Brake Handle Lever—activates device brakes.
4. Brake Pad—locks the wheel up in place.
5. Adjustment Tube Screw—adjusts the height of the device.
6. Steel Brake Cable—connects both the brake handle lever and the brake rod lever.
7. Roller—rotates the wheel.
8. Foldaway Roller Axle—holds up roller.
9. Brace Stop—prevents roller from sliding backwards.
10. Outer Tube—supports the sliding adjustment tube.
11. Wheel Axle—holds the wheel up.
12. Adjustment Tube—increases or reduces the manageability of the different tire sizes.
13. Steel Frame Structure—holds up the entire unit and its different parts.
14. Steel Pin—holds foldaway roller axle in place.

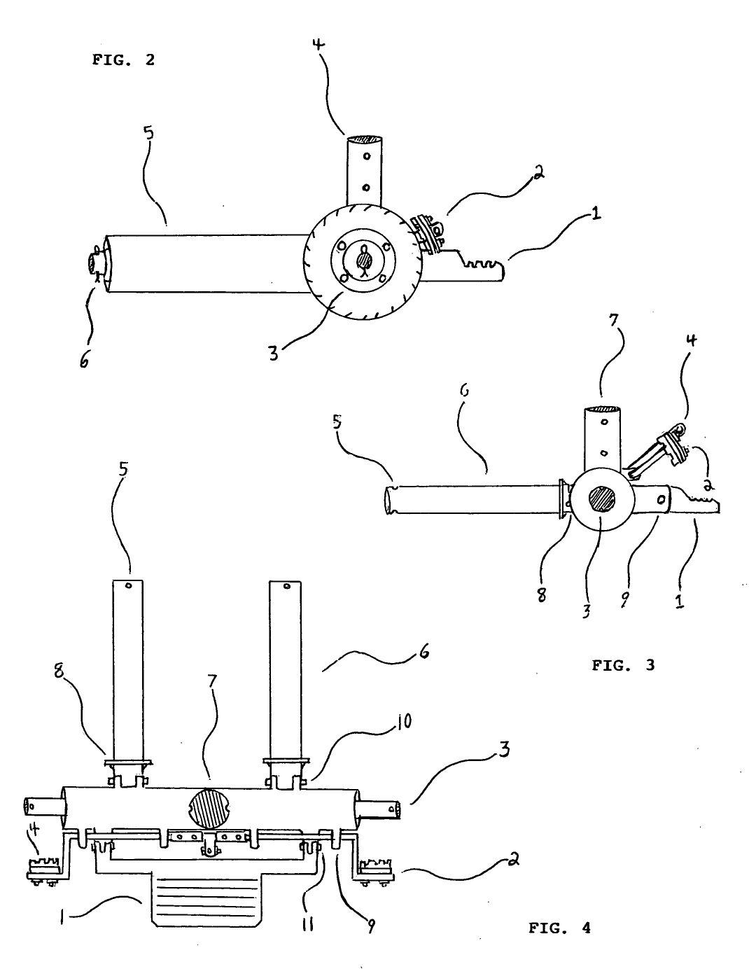

### FIG. 2

### Supplemental Left-Side View of Steel Frame Structure

1. Foldaway Step Pedal—helps control the device with the foot.
2. Unit of Brake Assembly—includes all the parts of the brake assembly (brake pads, rods, joints, and lever).
3. Entire Wheel Assembly—includes all the parts of the wheel assembly (wheels, axles, cotter pins, and washers).
4. Outer Tube Support Holes—houses bolts which secure the outer tube in place.
5. Roller Assembly—includes all the parts of the roller assembly (rollers, front and rear bearings, foldaway roller axles, brace stops, cotter pins, and steel pins).

### FIG. 3

### Left-Side View of Steel Frame Structure

1. Foldaway Step Pedal—helps control the device with the foot.
2. Brake Pad Rod—moves the brake pad to lock in place.
3. Wheel Axle—holds up wheel.
4. Brake Rod Lever—exerts pressure upon or releases brake pad.
5. Cotter Pin Hole—houses cotter pin.
6. Foldaway Roller Axle—holds up roller.
7. Outer Tube Support—holds up outer tube.
8. Steel Pin—holds and secures foldaway roller axle in place.
9. Steel Pin—holds and secures foldaway step pedal in place.

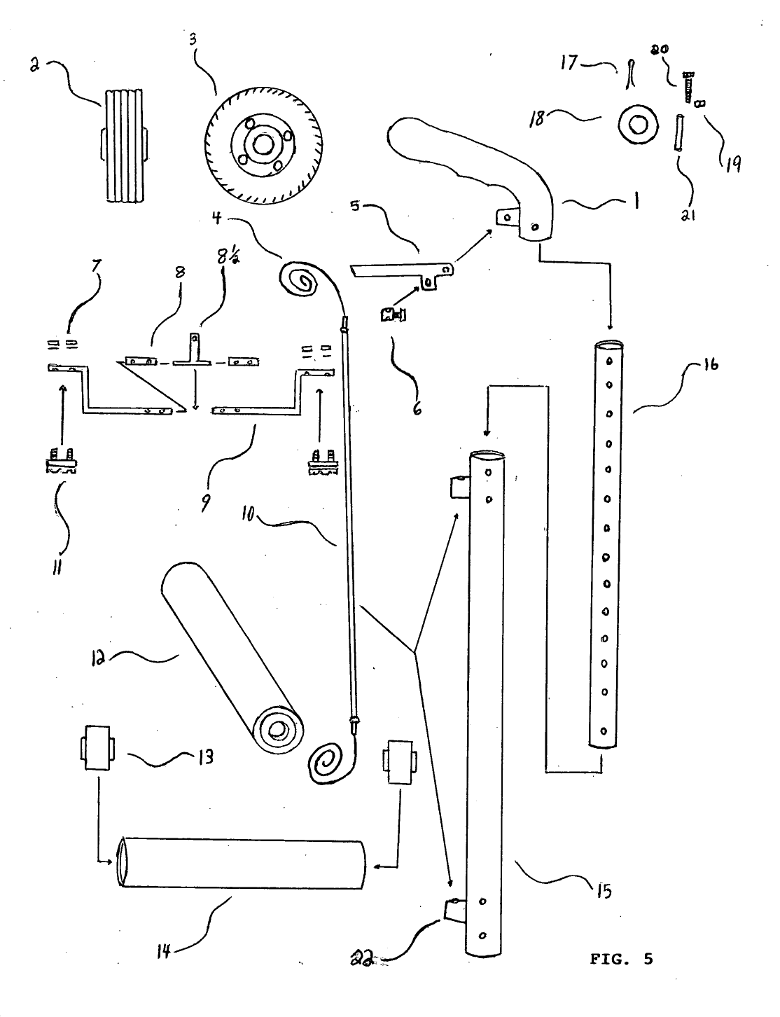

### FIG. 4

### Upper-Side View of Steel Frame Structure

1. Foldaway Step Pedal—helps control the device with the foot.
2. Brake Pad Rod—moves the brake pad to lock in place.
3. Wheel Axle—holds up wheel.
4. Brake Pad—locks the wheel up in place.
5. Cotter Pin Hole—houses cotter pin.
6. Foldaway Roller Axle—holds up roller.
7. Outer Tube Support—holds up outer tube.
8. Brace Stop—prevents roller from sliding backwards.
9. Brake Rod Supporters—hold up brake rods.
10. Steel Pin—holds and secures foldaway roller axle in place.
11. Steel Pin—holds and secures foldaway step pedal in place.

### FIG. 5

### Detailed Description of the Invention

1. Handle Grip—helps control the device with the foot. It slides onto the adjustment tube.
2. Straight View of Wheel.
3. Side View of Wheel.
4. Steel Brake Cable—connects both the brake handle lever and the brake rod lever.
5. Brake Handle Lever—activates device brakes. It connects to device's handle grip.
6. Brake Cable Adjustment Screw—adjusts the steel brake cable to parallel the adjustment tube's height. It is housed on the lower part of the brake handle lever.
7. Brake Pad Screws' Nuts and Washers—secure brake pads in place.
8. Brake Rod Joints—connect brake rods to brake rod lever. They overlap both the brake rods and brake rod lever.
8½. Brake Rod Lever—exerts pressure upon, or releases, brake pads
9.Brake Rods—move the brake pads to lock in place. They have two holes on each end to assemble the brake rod joints and the brake pads together.
10. Steel Brake Cable Tube—encases steel brake cable. It is installed on the adjoining supporters located at each end of the outer tube.
11. Brake Pad Units—lock up tires in place. They are installed at the far end of the brake rods.
12. Straight-view of Roller and Bearing.
13. Bearings—fit at each end of rollers to make them rotate.
14. Rollers—rotate the wheel. They are installed along with bearings on foldaway roller axles.
15. Outer Tube—supports and encases the sliding adjustment tube. It is installed on top of the outer tube support.
16. Adjustment Tube—increases or reduces the manageability of the different tire sizes. It is installed inside the outer tube. It contains several holes lengthwise to adjust the height of the device to enable it to handle different tire sizes.
17. Cotter Pins—secure parts in proper place.
18. Washers—will be used as spacers.
19. Lock-nuts—lock bolts in place.
20. Bolts—are used to assemble the device together.
21. Steel Pins—hold and secure both the foldaway step pedal and the foldaway roller axles in their proper place.
22. Brake Cable Tube Supporters—hold up brake cable tube in place.

Any person will be able to use this device by following the next steps: To Remove A Wheel
a) Loosen lugnuts but do not remove them.
b) Roll device underneath the tire by pushing it with one foot on the step pedal.
c) Setting one foot on the step pedal, pull the device's handle grip backwards (towards you), applying pressure on the brakes at the same time, to place rollers in position.
d) Remove all lugnuts from studs to free the wheel.
e) Grab the tire with one hand, release the brakes, pull the device backwards (towards you) and the wheel comes off.

### To Install a Wheel

a) Unfold the rollers and the step pedal.
b) Apply pressure on the brake handle lever to lock the wheels up to prevent the device from moving.
c) Roll tire onto device's rollers.
d) Tilting the device's handle grip backwards (towards you) and exerting pressure on the brake handle lever, align the wheel's holes with the rotor's studs by rotating the tire with your hand.
e) Release the brakes and push the device forward using your foot to apply force on the step pedal.
f) Once the wheel is in place, make sure to screw the lugnuts back onto the studs to prevent the wheel from slipping off before removing the device (The Easy Tire Lift) from its position.

1. We, the sole inventors, claim this device, The Easy Tire Lift.
We claim our invention, The Easy Tire Lift, as being only ours.
